(19) United States
(12) Patent Application Publication
(10) Pub. No.: US 2012/0251058 A1
(43) Pub. Date: Oct. 4, 2012

(54) COMMUNICATIONS CABLE HAVING ELECTRO-OPTICAL TRANSCEIVERS AND METHOD OF USING SAME

(76) Inventors: Paul Kolesar, McKinney, TX (US); Terry R. Cobb, Ft Worth, TX (US); Lance Cobb, FT. Worth, TX (US)

(21) Appl. No.: 13/432,310

(22) Filed: Mar. 28, 2012

Related U.S. Application Data
(60) Provisional application No. 61/468,784, filed on Mar. 29, 2011.

(51) Int. Cl. G02B 6/36

(52) U.S. Cl. 385/92

(57) ABSTRACT

A communications cable includes a first electro-optical transceiver mounted in a first housing, the first housing being configured to electrically connect the first electro-optical transceiver to an electrical connector, a first keyed connector half connected to the first housing, the first keyed connector half including at least one first key element, and an optical cable having a first end connected to the first keyed connector half. Also a method of using such a communications cable.

### CROSS-REFERENCE TO RELATED APPLICATIONS

The present application claims the benefit of U.S. Provisional Application No. 61/468,784, filed Mar. 29, 2011, the entire contents of which are hereby incorporated by reference.

### FIELD OF THE INVENTION

The present invention is directed to a communications cable having at least one electro-optical transceiver connected to an optical cables and to a method of using same, and, more specifically, to an active optical communications cable having first and second electro-optical transceivers connected to a length of optical fiber by keyed optical connectors and toward a method of using same.

### BACKGROUND OF THE INVENTION

An active optical cable (AOC) is an optical cable having electro-optical transceivers affixed to either end to form a functional unit that constitutes a closed optical link. A conventional AOC having a first housing 300 containing a first electro-optical transceiver 302 and a second housing 304 containing a second electro-optical transceiver 306 connected by an optical cable 308 is illustrated in FIG. 12. AOC's are proprietary solutions that may be provided by different transceiver vendors. Although the transceiver optical parameters and sometimes the cable need not comply with standards, the transceivers are typically configured to plug into a standard electrical interface, such as a CX4 or a QSFP, on a switch or server, etc. Thus the AOC's appear to be standard devices when viewed plug to plug. In other words, the interface looks standard to the box it connects to even though elements inside and/or between the plugs may be non-standard.

AOC's are beneficial in high speed computing environments, and their use in data centers is expected to increase. They may be used, for example, to replace short copper interconnects at speeds of 10, 40, 100 Gb/s, and may be used over distances from a few meters up to about 2 km.

While useful, AOC's also have limitations. For example, the presence of the transceivers in housings on either end of the cable may make the cable difficult to pull through a channel during installation in the manner of a conventional cable, at least without damaging or dislodging the transceivers. Additionally, because the AOC's are unitary, if one of the transceivers fails the entire AOC must be replaced. Furthermore, the length of the cable connecting the transceivers cannot be adjusted. One must therefore either order custom AOC's in a desired length, which increases cost, or a vendor must stock a large number of different AOC's having lengths varying from a few meters to hundreds of meters, for example. Also structured cabling is no longer used to connect the systems. This removes the flexibility of reconfiguring the cabling at patch panels.

Beneficially, AOC's generally cost less than standards-based solutions because it is not necessary to make all components interoperate with all other components. For example, as long as the transceivers at both ends of the AOC can communicate with one another, it does not matter whether the transceivers also interoperate with other, conventional transceivers. The electrical signals output from either end of the AOC are usable by standards-based devices. It would be desirable to provide an AOC that can avoid damage from being pulled though a channel and the length of which can readily be adjusted while ensuring the interoperability of the transceivers on either end of the cable.

### SUMMARY OF THE INVENTION

These and other problems are addressed by embodiments of the present invention, a first aspect of which comprises a communications cable having a first electro-optical transceiver mounted in a first housing that is configured to electrically connect the first electro-optical transceiver to an electrical connector. The cable also includes a first keyed connector half connected to the first housing, the first keyed connector half comprising at least one first key element, and an optical cable having a first end connected to the first keyed connector half.

Another aspect of the invention comprises a communications cable having a first electro-optical transceiver mounted in a first housing, the first housing being configured to electrically connect the first electro-optical transceiver to an electrical connector, the first housing also being connected to a first keyed connector half. The communications cable also includes a second electro-optical transceiver mounted in a second housing, the second housing being configured to electrically connect the second electro-optical transceiver to an electrical connector, and the second housing being connected to a second keyed connector half. A length of optical cable having first and second ends is provided, the first end having a third keyed connector half connected to the first keyed connector half and the second end having a fourth keyed connector half connected to the second keyed connector half. The first keyed connector half includes first key means for preventing the first keyed connector half from connecting to a non-complementary connector, and the second keyed connector half includes second key means for preventing the second keyed connector half from connecting to a non-complementary connector.

An additional embodiment of the invention comprises a method of changing a length of a communications cable. The communications cable includes a first housing containing a first electro-optical transceiver, and the first housing is configured to connect the first electro-optical transceiver to an electrical connector and is connected to a first keyed connector half. The cable also includes a second housing containing a second electro-optical transceiver, and the second housing is configured to connect the second electro-optical transceiver to an electrical connector and is connected to a second keyed connector half. A first length of optical cable has a third keyed connector half complementary to the first keyed connector half connected to the first keyed connector half and a fourth keyed connector half complementary to the second keyed connector half connected to the second keyed connector half. The method involves disconnecting the third keyed connector half from the first keyed connector half, disconnecting the fourth keyed connector half from the second keyed connector half, and moving the first length of optical cable away from the first keyed connector half and the second keyed connector half. The method also includes providing a second length of optical cable having a length different than a length of the first length of optical cable, the second length of optical cable having a fifth keyed connector half complementary to the first keyed connector half and a sixth keyed connector half complementary to the second keyed connector half, connecting the fifth keyed connector half to the first keyed connector half, and connecting the sixth keyed connector half to the second keyed connector half.

### BRIEF DESCRIPTION OF THE DRAWINGS

These and other features and benefits of the invention will be better understood after a reading of the following detailed description together with the attached drawings wherein:

FIG. 1 is a top plan view of a communications cable having first and second housings joined to an optical cable by keyed connector halves according to a first embodiment of the present invention.

FIG. 2 is a top plan view of a communications cable having first and second housings joined to an optical cable by keyed connector halves according to a second embodiment of the present invention.

FIG. 3 is a front elevational view of one of the keyed connector halves of FIG. 1.

FIG. 4 is a front elevational view of a keyed connector half complementary to the keyed connector half of FIG. 3.

FIG. 5 is a front elevational view of an alternate version of one of the keyed connector halves of FIG. 1.

FIG. 6 is a front elevational view of a keyed connector half complementary to the keyed connector half of FIG. 5.

FIG. 7 is a front elevation view of a keyed connector half according to a further embodiment.

FIG. 8 is a front elevational view of a keyed connector half according to another embodiment.

FIG. 9 is a side elevational view of an alternative optical cable that may replace the optical cable of FIG. 1.

FIG. 10 is a flow chart illustrating method according to the present invention.

FIG. 11 is a perspective view of a conventional MPO plug and receptacle.

FIG. 12 is a top plan view of a conventional active optical cable.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

Various types or classes of connectors are known. For example, RJ-45 connectors comprise plugs and sockets, and plugs and sockets formed according to this standard are all mutually compatible. Another class of connector is an MPO connector which includes a plug and socket that is used on a device such as a transceiver. The MPO connector system also includes a plug-adapter-plug configuration in which the plugs terminate cables and the adapter joins the plugs together. Any plug element and socket element made as MPO elements are mutually connectable and compatible. RJ-45 connectors include an angled release tab that fits in a notch on a jack, and MPO connectors include a ridge on one side of a plug that fits into a slot on the receptacle or adapter to ensure that the components are connected in the proper orientation, as shown in FIG. 11. These components are not “keyed” connector halves as this phrase is used in the present application. Rather, these features are a part of the overall shape of the respective connector components, and conventional plugs, receptacles and adapters are formed in these shapes to be interconnectable with a large number of other connectors.

As used herein, a keyed connector constitutes two connector halves that would be connectable in an unkeyed form (two MPO connectors, for example) which are further provided with key elements that limit the number of other connector halves to which they will connect. A first keyed connector element thus includes a key element that is configured to engage a key element on a second keyed connector (or on an adapter in the case of MPO connectors). For example, one of the first and second connector halves may include one or more projections that are received in a complementary one or more slots on the other of the second and first connector halves when the first keyed connector half is connected to the second keyed connector half. The phrase keyed connector halves is not intended to cover two connector halves that are not compatible—an RJ-45 plug cannot be connected to an MPO receptacle, but this does not make those elements “keyed.” To constitute a keyed connector half as used herein, the connector halves themselves must be of types that would be compatible and connectable but for the presence of the key elements.

In addition, as used herein, a “key element” is an element on a keyed connector half that either prevents that keyed connector half from being inserted into or from receiving another keyed connector half. It may constitute, for example, a projection at one surface of a first keyed connector half or a slot adapted to accommodate such a projection, the slot being formed on the other keyed connector half.

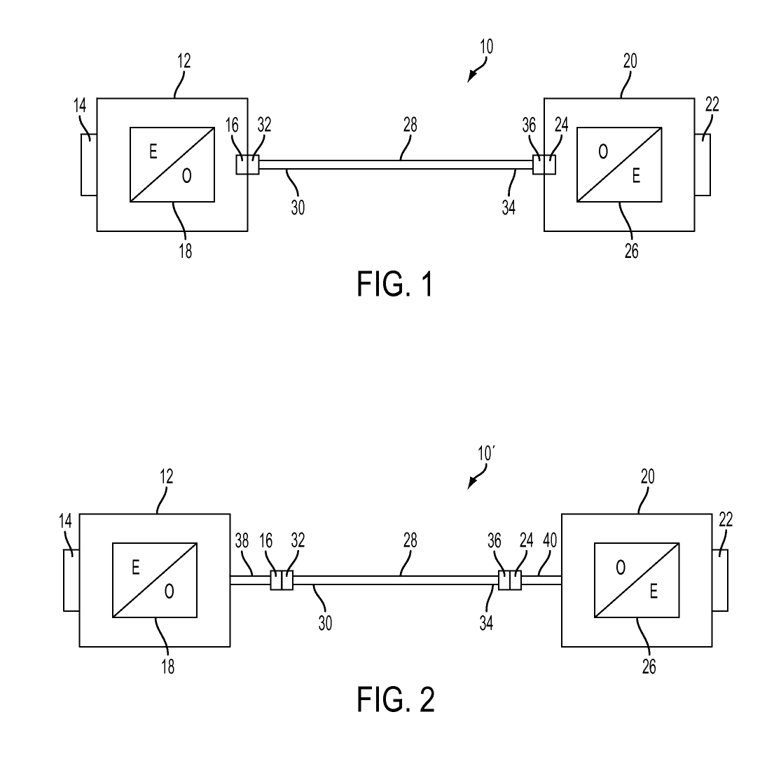

FIG. 1 illustrates a communications cable 10, in this case, an active optical cable (AOC) according to a first embodiment of the present invention. The communications cable 10 comprises a first housing 12 having a first electrical connector 14 configured to connect to a conventional electrical connector on a computer or telecommunications module (not illustrated) and a first keyed connector half 16. The first housing 12 includes a first electro-optical converter 18 in communication with the first electrical connector 14 and the first keyed connector half 16. Electrical signals received at the first electro-optical converter 18 are converted to optical signals by the first electro-optical converter 14 and forwarded to the first keyed connector half 16. Furthermore, optical signals received at the first housing 12 via the first keyed connector half 16 are converted to electrical signals by the first electro-optical converter 14 and forwarded to the first electrical connector 14. The cable 10 also includes a second housing 20 having a second electrical connector 22 configured to connect to a conventional electrical connector (not illustrated) and a second keyed connector half 24. The second housing 20 includes a second electro-optical converter 26 in communication with the second electrical connector 22 and the second keyed connector half 24. The second electro-optical converter converts optical signals to electrical signals and electrical signals to optical signals in the same manner as the first electro-optical converter 14. The first keyed connector half 16 and the second keyed connector half 24 are either identical or complementary to each other.

An optical cable 28 has a first end 30 having a third keyed connector half 32 and a second end 34 having a fourth keyed connector half 36. The third keyed connector half 32 is complementary to the first keyed connector half 16, and the fourth keyed connector half 36 is complementary to the second keyed connector half 24. If the first keyed connector half 16 is identical to the second keyed connector half 24, then the third and fourth keyed connector halves 32, 36 will be identical to one another and complementary to each of the first and second keyed connector halves 16, 24. This will allow optical cable 28 to be connected between the first housing 12 and the second housing 20 in either direction. If the first and second keyed connector halves 16, 24 are complementary instead of identical, one of the third and fourth keyed connector halves 32, 36 must be selected to be complementary to the first keyed connector half 16 and the other of the third and fourth keyed connector halves 32, 36 must be complementary to the second keyed connector half 24. Because it is generally desirable to ensure that the first electro-optical transceiver 18 is only connected to a compatible electro-optical transceiver, such as second electro-optical transceiver 26, it is generally preferred to make the first keyed connector half 16 identical to the second keyed connector half 24.

By making the first and second housings 12, 20, disconnectable from the optical cable 28, the length of the communications cable 10 can be adjusted by using any desired length of optical cable 28 capable of being supported by the transmission capability of the electro-optical converters within housings 12 and 20, and the optical cable 28 can be pushed or pulled through passageways too small to accommodate one of the first or second housings 12, 20. Feeding the optical cable 28 through a passage with the first housing 12 disconnected also avoids the possibility of damaging the electro-optical converter 18 inside the first housing 12 by dragging it along a passageway. However, as discussed above, the first and second electro-optical converters 18, 26, are configured to be compatible, but not all electro-optical converters are mutually compatible. Making the first and second housings disconnectable could therefore lead to compatibility problems. These problems are substantially avoided by the use of keyed connector halves to ensure that only compatible electro-optical converters will be interconnected.

While AOC's that include a permanently affixed transceiver on each end are useful, it is also possible to use one electro-optical transceiver with affixed length of optical cable to connect an electrical connection on one piece of equipment to an optical connection on another piece of equipment, or to use one electro-optical transceiver with affixed length of optical cable to connect an electrical connection on a first piece of equipment and a second electro-optical transceiver with affixed length of optical cable to connect an electrical connection on a second piece of equipment and then interconnect the first and second transceivers with another optical cable. Thus such electro-optical transceivers with affixed length of cable may function to replace conventional electro-optical transceivers plus conventional equipment cords which connect equipment ports to patch panels. Such utility creates devices that may be referred to as active equipment cords (AECs). An AEC could be formed by disconnecting the fourth keyed connector 36 from the second keyed connector 24 and connecting the fourth keyed connector 36 to an optical connector (not illustrated) on a piece of computer or telecommunications equipment (not illustrated). Of course, the connector on the piece of telecommunications equipment would have to be keyed to be compatible with the fourth keyed connector half 36 in order to ensure compatibility between the piece of equipment and the electro-optical transceiver 18 in the first housing 12.

FIG. 2 illustrates a communications cable 10′ that uses two AECs described in paragraph 0035 and that is a variation on the communication cable 10 of the first embodiment wherein elements common to the embodiment of FIG. 1 are identified with like reference numerals in this figure. In FIG. 2, the first housing 12 includes a first segment 38 of optical cable fixedly attached thereto on one end and terminated in connector half 16 on the other end, and the third keyed connector half 32 is attached to the end of this first segment 38 at connector half 16. The second housing 20 also includes a second segment of optical cable 40 fixedly attached thereto on one end and terminated in connector half 24 on the other end, and the fourth keyed connector half 36 is attached to the second segment 40 at connector half 24. The communications cable 10′ of the second embodiment functions in the same manner as the communications cable 10 of the first embodiment, but spacing the third keyed connector half 32 from the first housing 12 and the second keyed connector half 36 from the second housing 20 may make for easier interconnections of the various keyed connector halves under some circumstances. Moreover, the communications cable 10′ may be constructed by cutting a middle portion out of a conventional AOC to leave segments or “pigtails” on two transceiver housings and then applying connector halves to these pigtails so that they can connect to a new length of optical cable and thus be used as AEC's as described above.

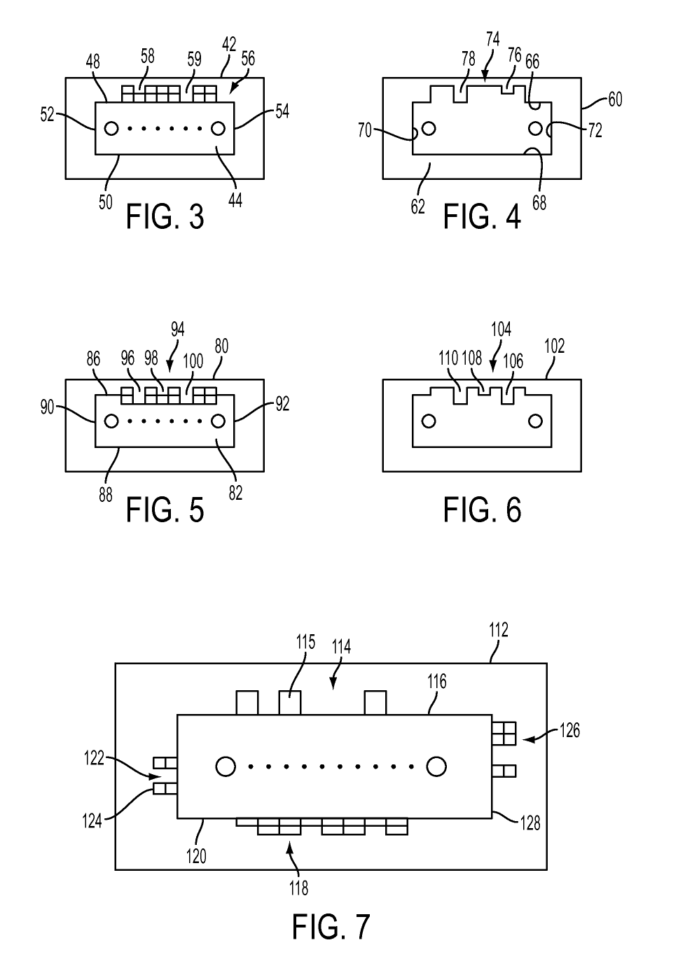

Examples of suitable keyed connector arrangements will be described below, it being understood that other keyed connectors having alternate configurations for preventing the connection of potentially incompatible connector halves, could likewise be used. FIG. 3 shows the end of a first keyed connector half 42 having a front mating face 44, and a top surface 48, a bottom surface 50, a first side surface 52 on the left side of FIG. 3 and a second side surface 54 on the right side of FIG. 3. In FIG. 3, a first key element 56 is arranged on the top surface 48 but could just as easily be arranged on any one of the bottom surface 50 or first or second side surfaces 52, 54. The first key element 56 may be pictured as a rectangular eight-by-two array of elements, one or more of which can be removed to produce a slot or isolated to produce a projection. In this case, the first element in the second column from the left has been removed to form a shallow slot 58 and both elements in the sixth column from the left have been removed to form a deeper slot 59.

FIG. 4 illustrates a second keyed connector half 60 having a front mating face 62, and a top surface 66, a bottom surface 68, a first side surface 70 on the left side of FIG. 4 and a second side surface 72 on the right side of FIG. 4. The second keyed connector half 60 includes a second key element 74 complementary to the first key element 56 of FIG. 3. The second key element 74 includes a first, relatively short projection 76 configured to engage the shallow slot 58 of the first key element 56 and a second, longer projection 78 configured to engage the deeper slot 59 of the first key element 56.

FIG. 5 illustrates another example of a keyed connector half 80 having a front mating face 82, and a top surface 86, a bottom surface 88, a first side surface 90 on the left side of FIG. 5 and a second side surface 92 on the right side of FIG. 5. In FIG. 5, a first key element 94 is arranged at the top surface 86 and extends partially into the top surface 86. Of course, the first key element 94 could alternately be formed in one of the first and second sides surfaces 90, 92 or the bottom surface 88 in a similar manner. The first key element 94 includes a first deep notch 96 in the second column of elements, which extends into the top surface 86, a shallow notch 98 in the fourth column of elements and a second deep notch 100. FIG. 6 illustrates a second keyed connector half 102 having a key element 104 comprising a first long projection 106 configured to be received in first deep notch 96, a short projection 108 configured to be received in the shallow notch 98 of the first key element 94 and a second long projection 110 configured to be received in the second deep notch 100 of the first key element 94. The projections and notches may have shapes other than the disclosed squares and rectangles. For example, triangular or semicircular elements, or elements having other shapes, could be used within the scope of this invention.

It is generally possible to provide slots and/or projections on either one of a pair of keyed connector halves to ensure compatibility. In the case of MPO connectors, MPO plugs are made to plug into receptacles which may be formed in a piece of equipment or in an adapter that has two receptacles for connecting two MPO plugs together. As discussed above and as illustrated in FIG. 11, MPO plugs 160 generally include an alignment ridge 162, and MPO receptacles 164 include a notch 166 to receive this ridge 162. It may therefore be desirable in the case of MPO connectors to provide key elements in the form of projections on MPO receptacles in the notches and key elements in the form of slots on the ridges of MPO plugs. This ensures that only properly keyed plugs may be inserted into a keyed receptacle. A plug configured as illustrated in FIG. 5, or an unkeyed plug having an alignment ridge, cannot be inserted into the keyed receptacle illustrated in FIG. 4. However, if the MPO plugs at either end of a length of optical cable are keyed with slots, these plugs will still be usable in unkeyed receptacles—both in equipment or in adapters. Lengths of optical cable 28 with keyed MPO plugs at either end can be inserted in complementary keyed receptacles and also in unkeyed receptacles because the slots in the keyed MPO plug will not prevent that MPO plug from being inserted into an unkeyed MPO receptacle. This allows a length of optical cable with keyed MPO connector halves at either end to be used in unkeyed environments as well as with complementary keyed MPO receptacles.

As discussed above, the first and second key elements can be thought of as eight by two arrays of elements, one or more of which can be removed to form slots and/or projections. Which of the keyed connectors will have the “slots” and which will have the projections will depend on how many of the 16 elements are removed. For example, FIG. 7 illustrates an embodiment of a first, plug keyed connector half 112, having a top key element 114 extending from a top surface 116, a bottom key element 118 extending from a bottom surface 120, a first side key element 122 extending from a first side surface 124 and a second side key element 126 extending from a second side surface 128. Top key element 114 comprises three projections 115 that are received in corresponding slots in a complementary keyed connector half (not illustrated). Of course, the projections 115 could alternately be thought of as partially defining very wide slots that receive wide projections on a complementary keyed connector half.

In practice, it may not be necessary to include a key element on each of the four disclosed surfaces; a single key element may be provided on any one of the side surfaces, or two key elements may be provided on opposite or adjacent sides of the keyed connector half 112, or three key elements may be provided. A single key element is often sufficient, but a greater number of keying arrangements can be provided by utilizing more than one side of a keyed connector half. The arrangement of slots and projections in each of the first, second, third and fourth key elements of keyed connector half 112, show various possibilities of arrangements for slots and projections but are not intended to be limiting.

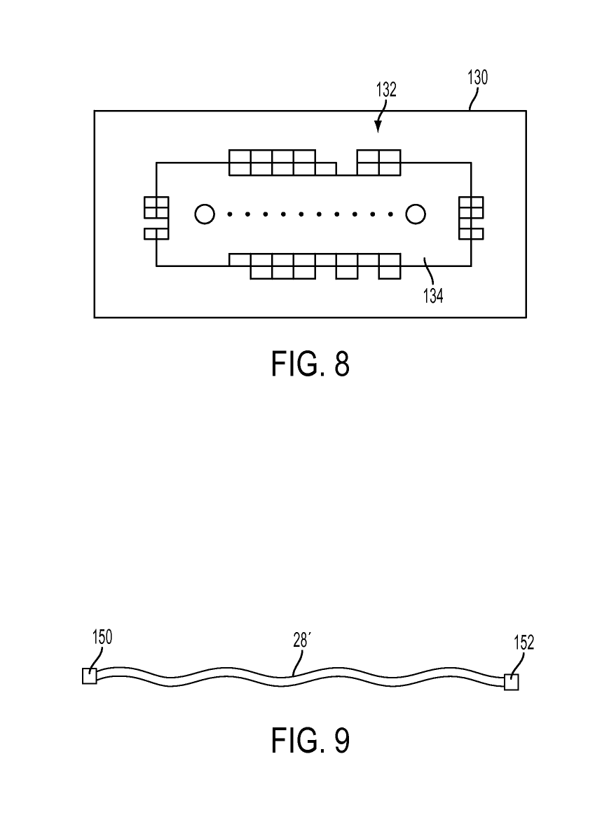

FIG. 8 illustrates a keyed connector half 130 according to another embodiment of the invention which differs from the keyed connector half 112 of the previous embodiment in that one row of the eight by two array that constitutes a key element 132 is formed within the body of the keyed connector half 130. Either projections or notches may be formed in either row of this key element 132, and complementary structures may be provided on the complementary key element of a complementary keyed connector half (not illustrated). Keyed connector half 130 is illustrated with key elements disposed around the periphery of a front mating face 134, but, as in the embodiment of FIG. 7, it may be desirable to provide key elements on only one or on fewer than all sides of the device.

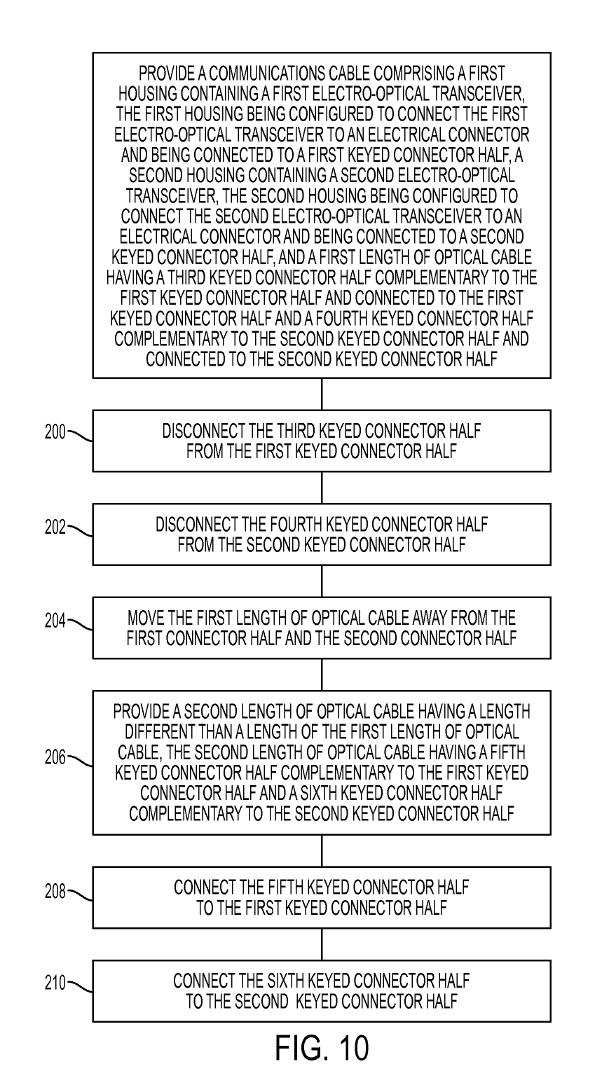

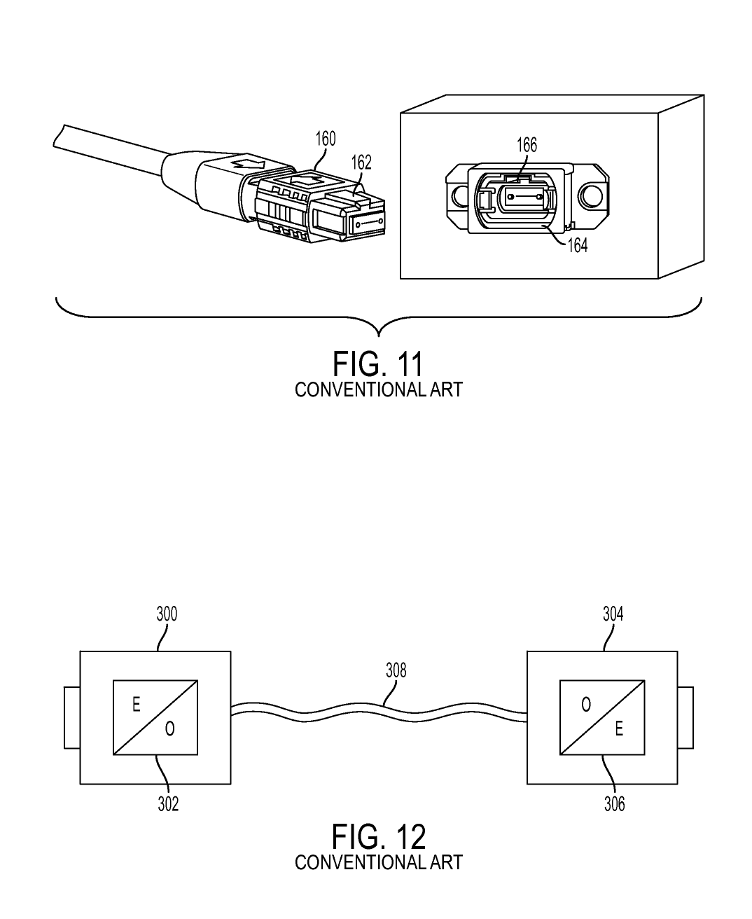

A method of adjusting the length of communications cable 10 will now be discussed in connection with FIG. 10. The method includes a step 200 of disconnecting the third keyed connector half 32 from the first keyed connector half 16, a step 202 of disconnecting the fourth keyed connector half 36 from the second keyed connector half 24, and a step 204 of removing the first length of optical cable 28. The method also includes a step 206 of providing a second length of optical cable 28′ (FIG. 9) having a length different than a length of the first length of optical cable 28, the second length of optical cable 28′ having a fifth keyed connector half 150 complementary to the first keyed connector half 16 and a sixth keyed connector half 152 complementary to the second keyed connector half 24, a step 208 of connecting the fifth keyed connector half 150 to the first keyed connector half 16, and a step 210 of connecting the sixth keyed connector half 152 to the second keyed connector half 24.

The present invention has been described herein in terms of several embodiments. Modifications and additions to these embodiments will become apparent to those of ordinary skill in the art after reading the foregoing disclosure. It is intended that all modifications and additions comprise a part of the present invention to the extent they fall within the scope of the several claims appended hereto.

What is claimed is:

1. A communications cable comprising:
a first electro-optical transceiver mounted in a first housing, the first housing being configured to electrically connect the first electro-optical transceiver to an electrical connector;
a first keyed connector half connected to the first housing, the first keyed connector half comprising at least one first key element; and
an optical cable having a first end connected to the first keyed connector half.

2. The communications cable of claim 1, further including:
a second electro-optical transceiver mounted in a second housing, the second housing being configured to electrically connect the second electro-optical transceiver to an electrical connector, and
a second keyed connector half connected to the second housing and to a second end of the optical cable, the second keyed connector half comprising at least one second key element.

3. The communications cable of claim 2, wherein the first end of the length of optical cable has a third keyed connector half having at least one third key element complementary to the at least one first key element and the second end of the length of optical cable has at least one fourth key element complementary to the at least one second key element.

4. The communications cable of claim 3, wherein the first keyed connector half comprises a receptacle and the first key element comprises a projection and wherein the third keyed connector half comprises a plug and the third key element comprises a slot into which the projection of the first key element extends.

5. The communications cable of claim 3, wherein the first keyed connector half comprises a receptacle and the first key element comprises a slot and wherein the third keyed connector half comprises a plug and the third key element comprises a projection extending into the slot in the first key element.

6. The communications cable of claim 3, wherein the at least one first key element comprises a primary key element and a secondary key element and the at least one second key element comprises a primary key element and a secondary key element.

7. The communications cable of claim 3, wherein each of the at least one first, at least one second, at least one third and at least one fourth key elements comprises a primary key element and a secondary key element.

8. The communications cable of claim 1, wherein the first keyed connector half is attached to the first housing by a segment of optical fiber.

9. The communications cable of claim 2, wherein the first keyed connector half is attached to the first housing by a first segment of optical fiber and the second keyed connector half is attached to the second housing by a second segment of optical fiber.

10. The communications cable of claim 2, wherein the first keyed connector half comprises a body with a front mating face and a top surface, bottom surface, left surface and right surface surrounding a perimeter of said front mating face and extending rearwardly from said front mating face and wherein said at least one first key element comprises a first slot in said body having a first depth and a second slot in said body having a second depth greater than said first depth.

11. The communications cable of claim 2, wherein the first keyed connector half comprises a body with a front mating face and a top surface, bottom surface, left surface and right surface surrounding a perimeter of said front mating face and extending rearwardly from said front mating face and wherein said at least one first key element comprises a first projection on said body having a first length and a second projection on said body having a second length greater than said first length.

12. The communications cable of claim 2, wherein the first keyed connector half comprises a body with a front mating face and a top surface, bottom surface, left surface and right surface surrounding a perimeter of said front mating face and extending rearwardly from said front mating face and wherein said at least one first key element comprises a projection on said body having a length and a slot in said body having a depth different than the length.

13. The communications cable of claim 2, wherein the first keyed connector half comprises a body with a front mating face and a top surface, bottom surface, left surface and right surface surrounding a perimeter of said front mating face and extending rearwardly from said front mating face and wherein said at least one first key element comprises a primary key element on a first one of said top surface, bottom surface, left surface and right surface and a secondary key element on a second one of said top surface, bottom surface, left surface and right surface, said primary key element comprising first and second slots having different depths or first and second projections having different lengths and said secondary key element comprising first and second slots having different depths or first and second projections having different lengths.

14. The communications cable of claim 12, wherein the first keyed connector half is attached to the first housing by a first segment of optical fiber and the second keyed connector half is attached to the second housing by a second segment of optical fiber.

15. The communications cable of claim 2, wherein the first keyed connector half and the second keyed connector half comprise MPO receptacles.

16. A communications cable comprising:
a first electro-optical transceiver mounted in a first housing, the first housing being configured to electrically connect the first electro-optical transceiver to an electrical connector, the first housing connected to a first keyed connector half;
a second electro-optical transceiver mounted in a second housing, the second housing being configured to electrically connect the second electro-optical transceiver to an electrical connector, the second housing being connected to a second keyed connector half; and
a length of optical cable having a first end having a third keyed connector half connected to the first keyed connector half and a second end having a fourth keyed connector half connected to the second keyed connector half,
wherein the first keyed connector half includes first key means for preventing the first keyed connector half from connecting to a non-complementary keyed connector half and the second keyed connector half includes second key means for preventing the second keyed connector half from connecting to a non-complementary keyed connector half.

17. The communications cable of claim 16, wherein the first keyed connector half is connected to the first housing by a first segment of optical cable and wherein the second keyed connector half is connected to the second housing by a second segment of optical cable.

18. The communications cable of claim 16, wherein the first keyed connector half and the second keyed connector half comprise MPO receptacles.

19. A method of changing a length of a communications cable, the communications cable comprising a first housing containing a first electro-optical transceiver, the first housing being configured to connect the first electro-optical transceiver to an electrical connector and being connected to a first keyed connector half, a second housing containing a second electro-optical transceiver, the second housing being configured to connect the second electro-optical transceiver to an electrical connector and being connected to a second keyed connector half, and a first length of optical cable having a third keyed connector half complementary to the first keyed connector half and connected to the first keyed connector half and a fourth keyed connector half complementary to the second keyed connector half and connected to the second keyed connector half, the method comprising:
disconnecting the third keyed connector half from the first keyed connector half;
disconnecting the fourth keyed connector half from the second keyed connector half;
moving the first length of optical cable away from the first keyed connector half and the second keyed connector half;
providing a second length of optical cable having a length different than a length of the first length of optical cable, the second length of optical cable having a fifth keyed connector half complementary to the first keyed connector half and a sixth keyed connector half complementary to the second keyed connector half;
connecting the fifth keyed connector half to the first keyed connector half; and
connecting the sixth keyed connector half to the second keyed connector half.

20. The method of claim 19 including feeding the second length of optical cable through a passageway smaller than a cross section of the first housing or the second housing before connecting the fifth keyed connector half to the first keyed connector half.
